(19) United States
(12) Patent Application Publication
(10) Pub. No.: US 2009/0060106 A1
(43) Pub. Date: Mar. 5, 2009

(54) DIVERSITY DEVICE

(76) Inventor: Shigeyuki KURAMOTO, Osaka (JP)

Correspondence Address: BIRCH STEWART KOLASCH & BIRCH, PO BOX 747, FALLS CHURCH, VA, 22040-0747, US

(21) Appl. No.: 12/190,702

(22) Filed: Aug. 13, 2008

(30) Foreign Application Priority Data
Aug. 29, 2007 (JP) 2007-223199

(51) Int. Cl. H04B 7/10

(52) U.S. Cl. 375/347

(57) ABSTRACT

The diversity device includes: a plurality of antennas via which electric wave signals are respectively received; and a plurality of front-end circuits for amplifying signal levels of the electric wave signals received via the plurality of antennas, respectively, target signal levels of output signals supplied from the plurality of front-end circuits being set in advance, the diversity device further including: a control section for comparing first gains of the plurality of front-end circuits; and a switch for selecting, in accordance with a comparison result obtained by the control section, an IF signal supplied from a front-end circuit, among the plurality of front-end circuits, having a smallest first gain. The above arrangement enables provision of the diversity device that is capable of (i) selecting, from among a plurality of electric wave signals, an electric wave signal which is receivable in a best condition and (ii) being downsized.

This Nonprovisional application claims priority under U.S.C. §119(a) on Patent Application No. 223199/2007 filed in Japan on Aug. 29, 2007, the entire contents of which are hereby incorporated by reference.

### FIELD OF THE INVENTION

The present invention relates to a diversity device capable of selecting, from among a plurality of electric wave signals received, an electric wave signal which is receivable in a best condition.

### BACKGROUND OF THE INVENTION

The widespread use of car navigation systems in recent years has promoted the development of a diversity device, serving as a receiver for automobile use which receives digital terrestrial broadcast, which receives broadcast signals in a good condition even in a moving car.

For instance, Patent Document 1 (Japanese Unexamined Patent Application Publication No. 237196/1994 (Tokukaihei 6-237196; published on Aug. 23, 1994)) discloses a diversity device that (i) causes broadcast signals, received via a plurality of antennas, to be subjected to frequency conversions so that intermediate frequency signals are generated, (ii) causes the intermediate frequency signals to be demodulated so that a plurality of received signals are generated so as to correspond to the broadcast signals received via the antennas, respectively, (iii) causes carrier-to-noise ratios (CN ratios) of the intermediate frequency signals to be compared with each other, and (iv) causes a signal received via an antenna which is in the best reception condition to be selected from among the plurality of received signals in accordance with comparison results obtained in (iii).

Patent Document 2 (Japanese Unexamined Patent Application Publication No. 297320/2004 (Tokukai 2004-297320; published on Oct. 21, 2004)) discloses a diversity device that (i) causes broadcast signals, received via a plurality of antennas, to be subjected to frequency conversions so that a plurality of intermediate frequency signals, corresponding to the broadcast signals received, are generated, (ii) causes signal levels and phases of the intermediate frequency signals to be adjusted, and then (iii) causes the intermediate frequency signals to be summed so that an intermediate frequency signal having a high CN ratio is generated.

Unfortunately, the diversity device disclosed in Patent Document 1 requires a complex circuit configuration for detecting the CN ratios of the intermediate frequency signals. This causes a problem that the diversity device cannot be downsized. Further, the diversity device selects, from among the plurality of received signals obtained by the demodulation of the intermediate frequency signals, the signal received via the antenna which is in the best reception condition. This causes the diversity device to include a plurality of demodulation circuits corresponding to the plurality of intermediate frequency signals, i.e. to include demodulation circuits as many as the antennas. This causes the diversity device of Patent Document 1 not to be further downsized.

In contrast, the diversity device disclosed in Patent Document 2 requires a single demodulation circuit for demodulating a single intermediate frequency signal. This is because the diversity device causes the signal levels and phases of the intermediate frequency signals to be adjusted, and then causes the intermediate frequency signals to be summed so that such a single intermediate frequency signal having a high CN ratio is generated. However, the diversity device of Patent Document 2 requires circuits (phase-shifting means), for adjusting the phases of the intermediate frequency signals, for the respective intermediate frequency signals. This also causes a problem that the diversity device of Patent Document 2 cannot be downsized. Further, the diversity device of Patent Document 2 is affected by the conditions of all of the broadcast signals received via the antennas. As such, the intermediate frequency signal obtained by the summation does not necessarily have the highest CN ratio.

The present invention addresses the problems discussed above, and aims to provide a diversity device that is capable of (i) selecting, from among a plurality of electric wave signals, an electric wave signal which is receivable in a best condition and (ii) being downsized.

### SUMMARY OF THE INVENTION

In order to address the problems discussed above, the diversity device of the present invention includes: a plurality of input terminals via which electric wave signals are respectively received; and a plurality of signal converter means for amplifying signal levels of the electric wave signals received via the plurality of input terminals, respectively, target signal levels of output signals supplied from the plurality of signal converter means being set in advance, the diversity device further including: comparing means for comparing first gains of the plurality of signal converter means; and selecting means for selecting, in accordance with a comparison result obtained by the comparing means, a first output signal supplied from a signal converter means, among the plurality of signal converter means, having a smallest first gain.

With the arrangement, the signal converter means amplify the signal levels of the electric wave signals received via the input terminals. The comparing means then compares the first gains of the signal converter means. Subsequently, the selecting means selects, in accordance with the comparison result, an output signal supplied from a signal converter means that has the smallest first gain.

The signal converter means are set in advance so that the output signals supplied from the signal converter means have predetermined target signal levels, respectively. This causes electric wave signals received via the input terminals to have a single signal level regardless of difference in the signal levels of the electric wave signals, in a case where the electric wave signals have signal levels of not lower than a certain level. Note that “the signal level of an electric wave signal is not lower than a certain level” intends to mean that the signal converter means require a minimal signal level in order to amplify the electric wave signals to have the target signal levels, respectively. This is because each signal converter means has generally an amplification limit to which an inputted signal is appropriately amplified, i.e., has a maximum gain.

As discussed above, the smaller first gain the signal converter means has, the higher level the electric wave signal, which is received via the input terminal, has. Further, the higher level the electric wave signal has, the better reception condition the electric wave signal, which is received via the input terminal, has. This is because the higher level the electric wave signal has, the higher electric field strength the electric wave, which reaches the input terminal, has. The diversity device of the present invention causes first gains of the signal converter means to be compared and then the output signal that is supplied from the signal converter means having the smallest first gain to be selected. This enables selection of the electric wave signal received via the input terminal that has the best reception condition.

The comparing means included in the diversity device of the present invention is so arranged as to compare first gains of the signal converter means and to control the selecting means. This allows fabrication of the comparing means with use of a general-purpose circuit, i.e. a simple logic circuit or the like. Consequently, the diversity device of the present invention does not require a complex circuit that detects and compares the CN ratios of electric wave signals received via the input terminal or of output signals supplied from the signal converter means. This makes it possible to downsize the diversity device.

As discussed above, the diversity device of the present invention is capable: of selecting, from among a plurality of electric wave signals, an electric wave signal which is in the best reception condition; and of being downsized.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 is a block diagram illustrating an arrangement of a diversity device in accordance with an embodiment of the present invention.

FIG. 2 is a block diagram illustrating an arrangement of a control section included in a diversity device in accordance with an embodiment of the present invention.

FIG. 3 is a block diagram illustrating an arrangement of a diversity device that includes IF-AGCs in accordance with an embodiment of the present invention.

FIG. 4 is a block diagram illustrating an arrangement of a control section included in a diversity device in accordance with another embodiment of the present invention.

FIG. 5 is a block diagram illustrating an arrangement of a diversity device that includes level detection circuits in accordance with another embodiment of the present invention.

FIG. 6 is a block diagram illustrating an arrangement of a diversity device that includes a digital signal memory section in accordance with another embodiment of the present invention.

FIG. 7 is a block diagram illustrating an arrangement of a diversity device that includes two digital demodulation sections in accordance with another embodiment of the present invention.

FIG. 8 is a block diagram illustrating an arrangement of a conventional diversity device for a comparative example.

### DESCRIPTION OF THE EMBODIMENTS

The following explains embodiments of the present invention with reference to the attached drawings.

### First Embodiment

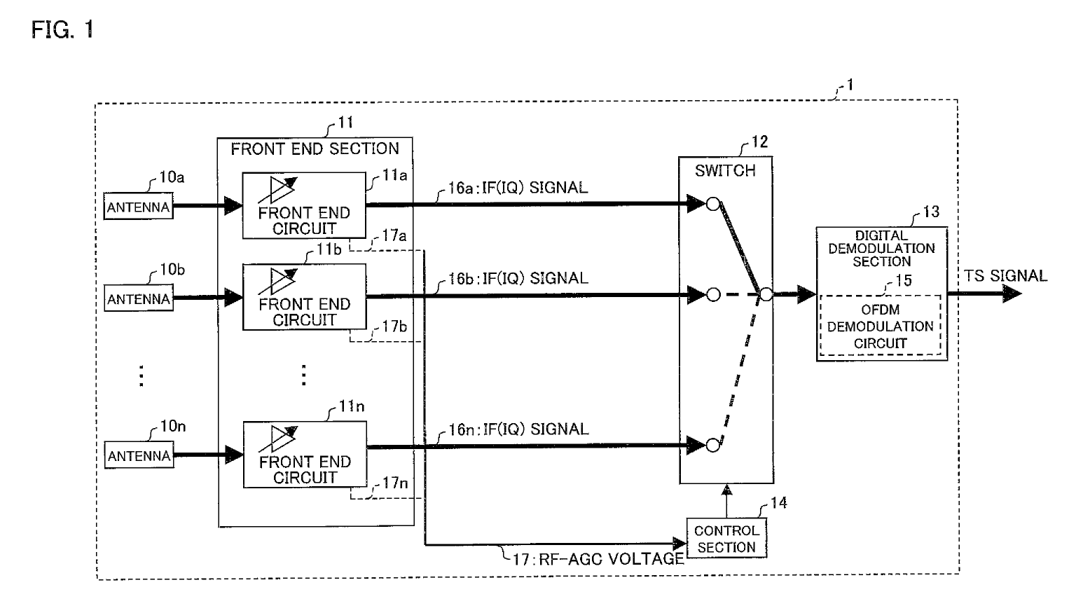

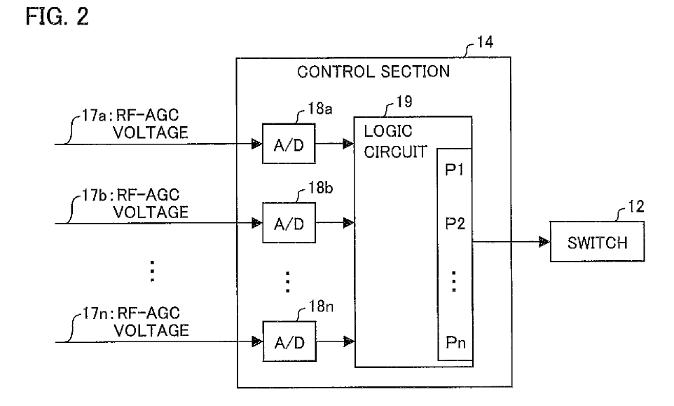

The first embodiment of the present invention will be described in detail below with reference to FIGS. 1 and 2.

(Arrangement of Diversity Device 1)

The following description deals with an arrangement of a diversity device 1 with reference to FIG. 1. FIG. 1 is a block diagram illustrating a basic arrangement of the diversity device 1 in accordance with an embodiment of the present invention.

As illustrated in FIG. 1, the diversity device 1 includes (i) a plurality of antennas 10a through 10n (hereinafter referred to as the antennas 10 when they are collectively referred to), (ii) a front-end section 11 that causes broadcast signals (electric wave signals) received via the antennas 10 (input terminals) to be subjected to amplification and frequency conversions and so that a plurality of intermediate frequency signals 16a through 16n (hereinafter referred to as the IF signals 16a through 16n, and referred to as the IF signals 16 when they are collectively referred to) are generated, (iii) a switch 12 (selecting means) which selects one of the IF signals 16a through 16n for the respective broadcast signals, (iv) a digital demodulation section 13 that includes an OFDM demodulation circuit 15 (first demodulator means) for digitally demodulating one of the IF signals 16 selected by the switch 12, and (v) a control section 14 (comparing means) that controls the switch 12.

Further, the front-end section 11 includes front-end circuits 11a through 11n (signal converter means) that cause the broadcast signals received via the antennas 10 (input terminals) to be subjected to amplification and frequency conversions so that the IF signals 16a through 16n are sent out.

(Operation of Diversity Device 1)

The following description deals with how the diversity device 1 operates, with reference to FIG. 1.

First, the front-end circuit 11a in the front-end section 11 receives a broadcast signal received via the antenna 10a. The IF signal 16a (i) are subjected to the frequency conversion by the front-end circuit 11a, (ii) are then amplified by a radio frequency auto gain control (RF-AGC) in the front-end circuit 11a so as to have a predetermined target level. Next, the front-end circuit 11a supplies to the switch 12 the IF signal 16a that has been subjected to the frequency conversion and the amplification. Similarly, the front-end circuits 11b to 11n cause broadcast signals received via the antennas 11b to 11n to be subjected to the respective frequency conversion and amplification, and then cause the IF signals 16b to 16n to be supplied to the switch 12.

The front-end circuits 11a to 11n supplies to the control section 14 RF-AGC voltages 17a to 17n (hereinafter referred to as the RF-AGC voltages 17 when they are collectively referred to) indicative of gains of the RF-AGCs in the front-end circuits 11a to 11n.

The control section 14 compares the RF-AGC voltages 17 supplied from the front-end section 11, and identifies a front-end circuit that has the smallest gain. Subsequently, the control section 14 supplies a control signal to the switch 12 so that the front-end circuit having the smallest gain is connected to the digital demodulation section 13. In response to the control signal from the control section 14, the switch 12 supplies to the digital demodulation section 13 one of the IF signals 16 that has received from the front-end circuit having the smallest gain. An arrangement and an operation of the control section 14 will be later described in detail.

The digital demodulation section 13 causes such one of the IF signals 16 to be demodulated into a digital signal with use of an orthogonal frequency division multiplexing (OFDM) demodulation circuit 15 in the digital demodulation section 13. The digital signal thus demodulated is sent out as a TS signal.

It should be noted that the smaller gain the RF-AGC has, the greater signal level a broadcast signal supplied via the antenna 10 has. This is because the RF-AGCs in the front-end circuits 11a to 11n amplify to the predetermined level intermediate frequency signals generated by the frequency conversion to which the broadcast signals are subjected. Further, the higher signal level the broadcast signal has, the better reception sensitivity the broadcast wave, which is received via the antenna 10, has, i.e., the broadcast wave is received in a better condition.

As described above, in the diversity device 1 of the present embodiment, gains of the front-end circuits 11a to 11n are compared with each other, and then a single IF signal 16 of a front-end circuit having the smallest gain is subjected to digital demodulation. This results in that the diversity device 1 selects a broadcast signal which is received in the best condition. This allows the diversity device 1 to send out a good TS signal having a high CN ratio.

As discussed above, in a diversity device 1 of the present embodiment, an IF signal 16 is selected which is received via an antenna 10 via which a broadcast signal is received in the best condition, and the IF signal 16 thus selected is demodulated into a digital signal by an OFDM demodulation circuit 15. This eliminates the need to provide the diversity device 1 with multiple OFDM demodulation circuits 15 as many as the antennas 10. This allows the diversity device 1 to be downsized.

Furthermore, the control section 14 is arranged so as to (i) compare RF-AGC voltages 17, supplied from front-end circuits 11a to 11n, and (ii) switch the switch 12 in accordance with the comparison result. This allows the control section 14 to be realized by a general-purpose circuit, i.e., a simple circuit. As a result, the diversity device 1 including the control section 14 is capable of being further downsized.

(Arrangement of Control Section 14)

The following describes an arrangement of the control section 14 with reference to FIG. 2. FIG. 2 is a block diagram illustrating an arrangement of the control section 14.

As illustrated in FIG. 2, the control section 14 includes (i) analog-to-digital conversion sections (A/D conversion sections) 18a to 18n (hereinafter referred to as A/D conversion sections 18 when they are collectively referred to that are provided to correspond to the RF-AGC voltages 17a to 17n supplied from the front-end section 11, respectively, and (ii) a logic circuit 19.

(Operation of Control Section 14)

The following describes how the control section 14 operates with reference to FIG. 2. The A/D conversion sections 18a to 18n receive the RF-AGC voltages 17a to 17n from the front-end section 11, respectively. The A/D conversion sections 18a to 18n convert the RF-AGC voltages 17, which are analog signals, into digital signals, and supply such digital signals to the logic circuit 19. The logic circuit 19 compares the digital signals to which the RF-AGC voltages 17a to 17n have been converted. The logic circuit 19 outputs a control signal causing the switch 12 to be controlled so that a front-end circuit having the smallest gain is connected to a digital demodulation section 13, in accordance with the result of the comparison performed by the logic circuit 19.

### COMPARATIVE EXAMPLE

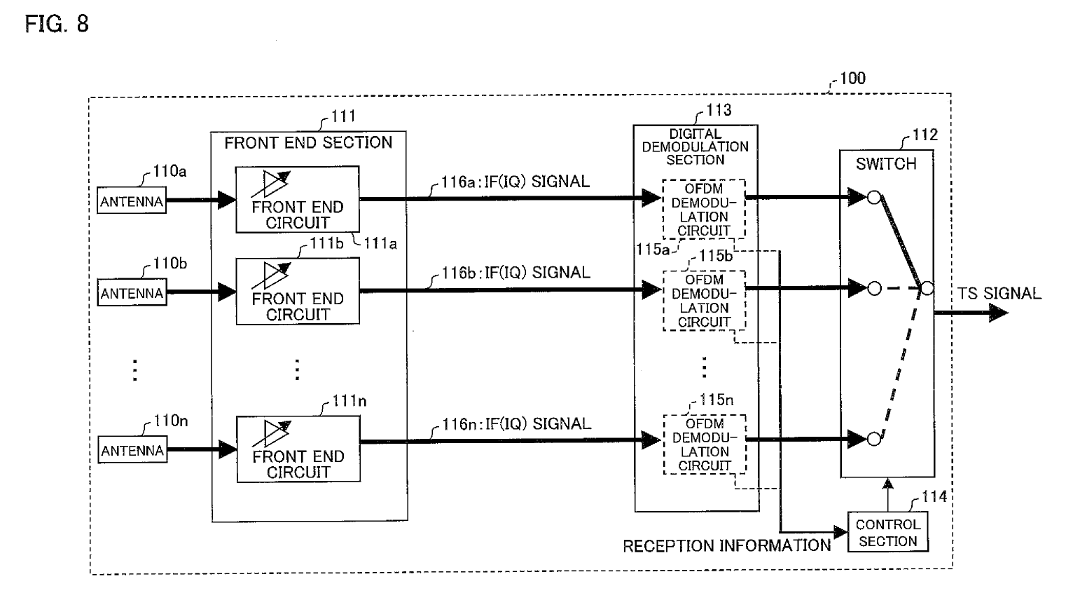

The following describes with reference to FIG. 8 a comparative example for the first embodiment. The comparative example includes a conventional diversity device 100 that includes OFDM demodulation circuits 115a to 115n as many as antennas. FIG. 8 is a block diagram illustrating an arrangement of the conventional diversity device 100.

(Arrangement of Diversity Device 100)

As illustrated in FIG. 8, the diversity device 100 includes (i) a plurality of antennas 110a through 110n (hereinafter referred to as the antennas 110 when they are collectively referred to), (ii) a front-end section 111 that includes front-end circuits 111a through 111n for generating IF signals 116a to 116n (hereinafter referred to as the IF signals 116 when they are collectively referred to) by causing broadcast signals supplied from the antennas 110 to be subjected to frequency conversions and amplification, (iii) a digital demodulation section 113 that includes a plurality of OFDM demodulation circuits 115a through 115n (hereinafter referred to as the OFDM demodulation circuits 115) for digitally demodulating the IF signals 116 supplied from the front-end section 111, (iv) a switch 112 that selects one of the digital signals that are supplied from the digital demodulation section 113, and sends out the signal selected, and (v) a control section 114 that controls the switch 112.

(Operation of the Diversity Device 100)

The following describes how the diversity device 100 operates. First, the front-end circuits 111a to 111n cause broadcast signals received via the antennas 110a to 110n to be subjected to frequency conversions and amplification, so that IF signals 116a to 116n corresponding to the broadcast signals are generated, respectively. The IF signals 116 supplied from the front-end section 11l are demodulated into digital signals by the OFDM demodulation circuits 115a to 115n in the digital demodulation section 113. Subsequently, the switch 12 selects, in accordance with a control signal supplied from the control section 114, one of the digital signals that are supplied from the OFDM demodulation circuits 115.

The control section 114 receives from the OFDM demodulation circuits 115a to 115n multiple pieces of information indicating reception conditions of the antennas 110; each of such pieces includes a bit error rate (BER) in demodulation or a CN ratio of each of the IF signals 116. The control section 114 then compares the multiple pieces of information thus supplied, and identifies an OFDM demodulation circuit 115 that has the best reception condition, i.e., that has the lowest BER or the highest CN ratio. Subsequently, the control section 114 supplies the control signal to the switch 112 so that a single digital signal supplied from the OFDM demodulation circuit 115 thus identified is sent out as a TS signal.

As described above, in the conventional diversity device 100, the OFDM demodulation circuits 115 are provided as many as the antennas 110, and a digital signal, generated from a broadcast signal that is received via an antenna which is in the best reception condition, is selected and sent out, by using reception information, indicative of reception condition, obtained from each of the OFDM demodulation circuits 115.

Unfortunately, the diversity device 100 requires complex reception control in order to control each of the OFDM demodulation circuits 115 and to switch between digital signals supplied from the OFDM demodulation circuits 115. Further, it is necessary to provide the OFDM demodulation circuits 115 as many as the antennas 110 so that the control section 114 selects, with use of the reception information, a digital signal generated from a broadcast signal that is received via the antenna which is in the best reception condition. Thus, the OFDM demodulation circuits 115 occupy a large portion of the space for mounting parts, which restricts the downsizing of the diversity device 100.

The first embodiment is described on the assumption that at least one of the broadcast signals received via the antennas 10 has a signal level of higher than a certain level. Specifically, if each of the broadcast signals received via the antennas 10 has a signal level of not higher than such a predetermined level, then all the RF-AGCs in the front-end circuits 11a to 11n have the maximum gain, i.e., have the same gain.

Each of the following second and third embodiments describes a diversity device of the present invention that can deal with in a case where each broadcast signal received via the antennas 10 has a signal level of not higher than a predetermined level.

It should be noted that the second and third embodiments explain constituent members different from those of the first embodiment, and that same members in the second and third embodiments as those in the first embodiment are assigned the same reference numerals and the description of the members is omitted.

### Second Embodiment

(Arrangement of Diversity Device 2)

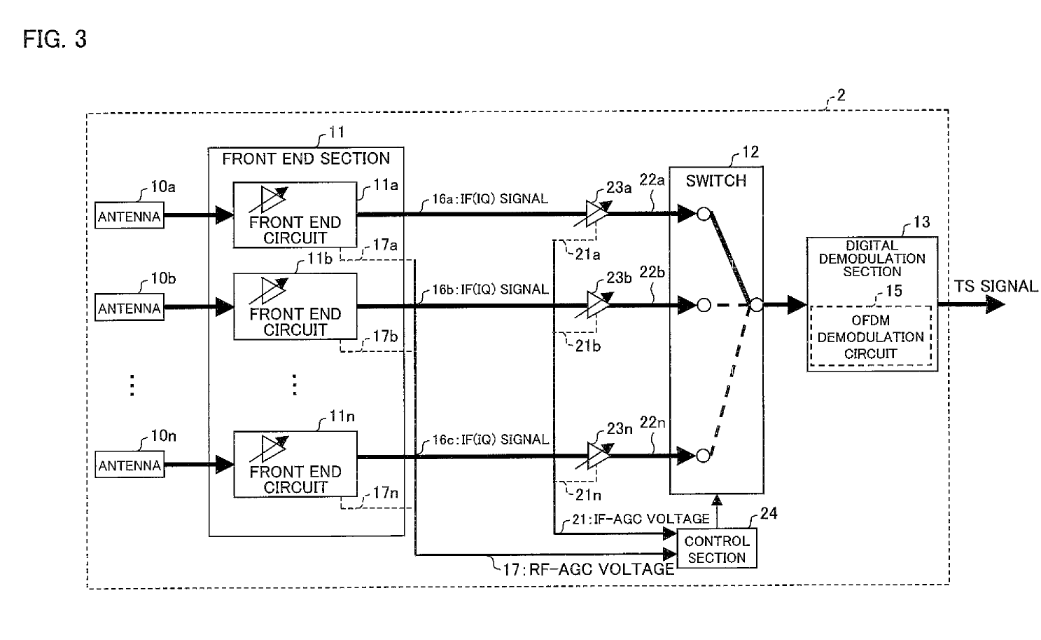

The following describes an arrangement of a diversity device 2 of the second embodiment with reference to FIG. 3. FIG. 3 is a block diagram illustrating an arrangement of the diversity device 2 in accordance with the embodiment of the present invention.

As illustrated in FIG. 3, the diversity device 2, further to the arrangement of the first embodiment, includes intermediate frequency auto gain controls (IF-AGCs) 23a to 23n (hereinafter referred to as IF-AGCs 23 when they are collectively referred to) that amplify the IF signals 16a to 16n, respectively. According to the second embodiment, in place of the control section 14 of the first embodiment, a control section 24 (comparing means; gain comparing means) is provided that receives (a) RF-AGC voltages 17 from the front-end section 11 and (b) IF-AGC voltages 21 from the IF-AGCs 23. The switch 12 of the second embodiment receives IF signals 22a to 22n that have been subjected to amplification by the IF-AGCs 23, respectively. The IF-AGC voltages 21 are signals indicative of gains of the IF-AGCs 23.

(Operation of Diversity Device 2)

First, the front-end section 11 converts broadcast signals received via the antennas 10a to 10n into the IF signals 16a to 16n, respectively. The IF signals 16a to 16n are amplified by the IF-AGCs 23a to 23n (amplifiers) so as to have predetermined levels, respectively, and are then supplied to the switch 12.

When at least one of the broadcast signals received via the antennas 10 has a signal level of higher than a predetermined level, the control section 24 (i) compares the RF-AGC voltages 17a to 17n supplied from the front-end circuits 11a to 11n and (ii) controls the switch 12 in accordance with the comparison result in (i) so that an IF signal 22, supplied from the IF-AGC 23 connected to the front-end circuit that has the smallest gain, is supplied to the digital demodulation section 13.

When all the broadcast signals received via the antennas 10 have signal levels of not higher than the predetermined level, all the front-end circuits 11a to 11n have a maximum gain, i.e., have the same gain. This causes the front-end section 11 to supply the IF signals 16a to 16n having a signal level of not higher than a predetermined target level. According to the IF-AGCs 23a to 23n, (i) the IF signals 16a to 16n are amplified so as to have the predetermined target level, and (ii) the IF signals 22a to 22n that have been subjected to the amplification are supplied to the switch 12.

The control section 24 receives (a) the RF-AGC voltages 17a to 17n from the front-end circuits 11a to 11n, respectively, and (b) the IF-AGC voltages 21a to 21n, which indicate gains of the IF-AGCs 23a to 23n, from the IF-AGCs 23a to 23n, respectively.

The control section 24 controls the switch 12 in accordance with the RF-AGC voltages 17a to 17n and the IF-AGC voltages 21a to 21n. Specifically, the control section 24 first compares the RF-AGC voltages 17a to 17n. If the comparison result reveals that the RF-AGC voltages 17a to 17n have the same gain, then the control section 24 compares the IF-AGC voltages 21a to 21n so as to identify an IF-AGC 23 having the smallest gain. Further, the control section 24 controls the switch 12 so that the switch 12 selects the IF signal 22 supplied from the IF-AGC 23 having the smallest gain and supplies the IF signal thus selected to the digital demodulation section 13.

The IF signal 16 received by the IF-AGC 23 having the smallest gain is an IF signal 16 into which a broadcast signal, received via an antenna 10 which is in the best reception condition, has been converted by the front-end section 11. Specifically, the IF signals 16 are amplified by the IF-AGCs 23 amplify so as to have a predetermined target level. Thus, the smaller gain the IF-AGC 23 has, the greater signal level the IF signal 16 has. Further, if all the broadcast signals received via the antennas 10 have signal levels of not higher than a certain level, then the front-end circuits 11a to 11n have the same gain. Therefore, the greater signal level the IF signal 16 has, the greater signal level the broadcast signal, supplied to the front-end section 11, has. Furthermore, the greater signal level the broadcast signal has, the better reception sensitivity the broadcast wave, which is received via the antenna 10, has.

As discussed above, a diversity device 2 of the second embodiment is capable of selecting a broadcast signal which is in the best reception condition, even in a case where all the broadcast signals received via the antennas 10 have signal levels of not higher than a certain level and therefore the front-end circuits 11a to 11n have the same gain.

(Arrangement of Control Section 24)

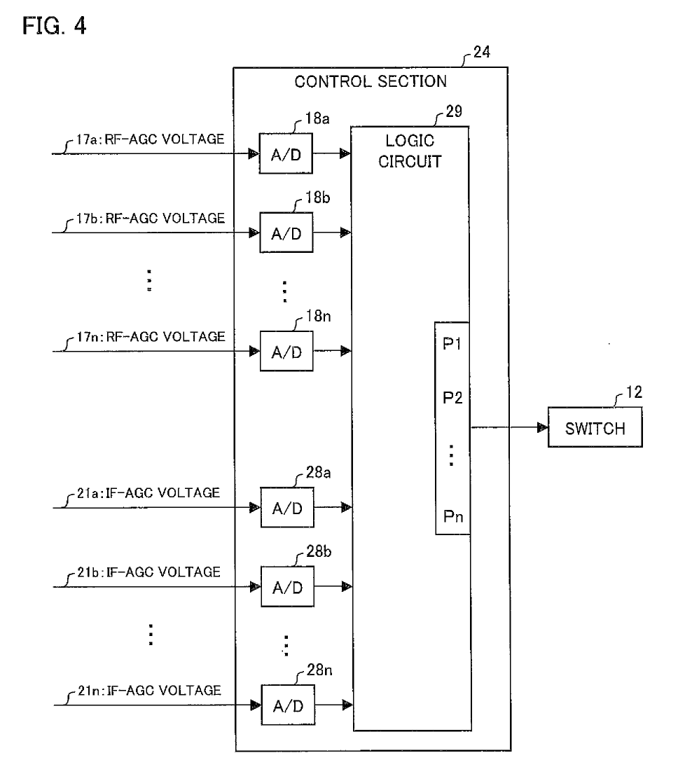

The following explains an arrangement of the control section 24 with reference to FIG. 4. FIG. 4 is a block diagram illustrating the arrangement of the control section 24.

As illustrated in FIG. 4, the control section 24 includes (i) A/D conversion sections 18a to 18n provided so as to respectively correspond to the RF-AGC voltages 17a to 17n supplied from the front-end section 11, (ii) A/D conversion sections 28a to 28n provided so as to respectively correspond to the IF-AGC voltages 21a to 21n supplied from the IF-AGCs 23, and (iii) a logic circuit 29.

(Operation of Control Section 24)

First, the A/D conversion sections 18a to 18n receive the RF-AGC voltages 17a to 17n from the front-end section 11, respectively Then, the A/D conversion sections 28a to 28n receive the IF-AGC voltages 21a to 21n from the IF-AGCs 23, respectively. Next, the RF-AGC voltages 17a through 17n are converted into digital signals by the A/D conversion sections 18a to 18n, respectively, and are supplied to the logic circuit 29. The logic circuit 29 compares the digital signals into which the RF-AGC voltages 17a to 17n have been converted. If the logic circuit 29 determines, based on the comparison of the RF-AGC voltages 17a to 17n, that all the front-end circuits 11a to 11n have the same gain, then the logic circuit 29 compares the digital signals into which the IF-AGC voltages 21a to 21n have been converted. Based on the comparison of the IF-AGC voltages 21a to 21n, the logic circuit 29 outputs a control signal for causing the switch 12 to be controlled so that the IF-AGC 23 having the smallest gain is connected to the digital demodulation section 13.

### Third Embodiment

(Arrangement of Diversity Device 3)

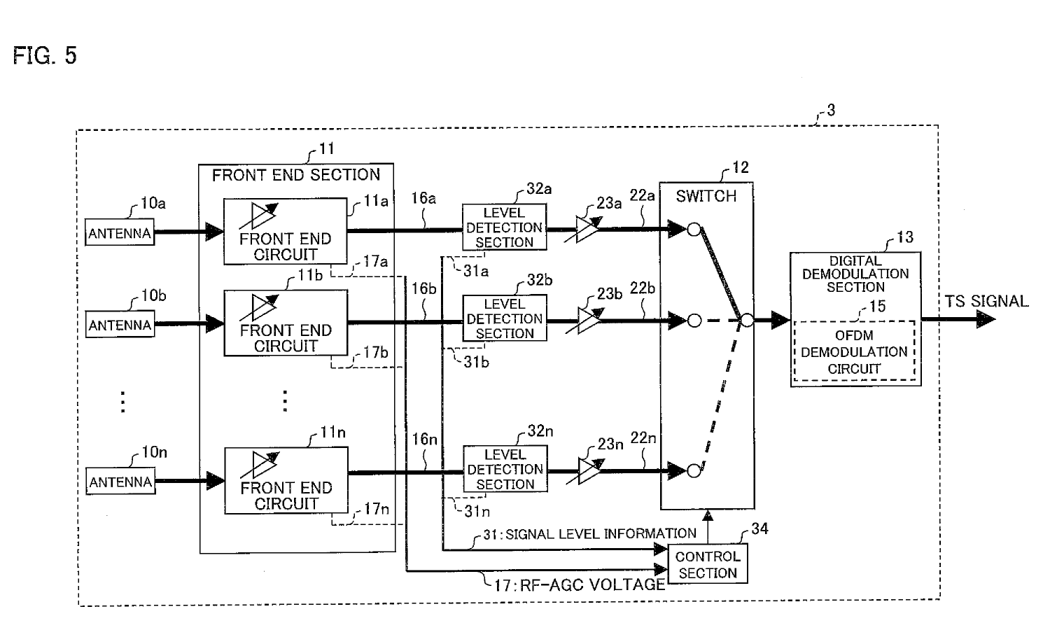

The following explains an arrangement of a diversity device 3 of the third embodiment with reference to FIG. 5. FIG. 5 is a block diagram illustrating an arrangement of the diversity device 3 in accordance with the embodiment of the present invention. It should be noted that the third embodiment explains constituent members different from those of the second embodiment, and that same members in the third embodiment as those in the second embodiment are assigned the same reference numerals and the description of the members is omitted.

As illustrated in FIG. 5, the diversity device 3, further to the arrangement of the second embodiment, includes level detection sections 32a to 32n (hereinafter referred to as level detection sections 32 when they are collectively referred to) that detect signal levels of the IF signals 16a to 16n, respectively. According to the third embodiment, in place of the control section 24 of the second embodiment, a control section 34 (comparing means; level comparing means) is provided that receives (a) the RF-AGC voltages 17 from the front-end section 11 and (b) signal level information 31 from the level detection sections 32.

(Operation of Diversity Device 3)

First, the front-end section 11 converts broadcast signals received via the antennas 10a to 10n into the IF signals 16a to 16n, respectively. Then, the level detection sections 32a to 32n (detection means) detect signal levels of the IF signals 16a through 16n, respectively. The level detection sections 32a to 32n supply to the control section 34 the signal level information 31a to 31n indicative of the signal levels of the IF signals 16a through 16n thus detected.

When at least one of the broadcast signals received via the antennas 10 has a signal level of higher than a certain level, the control section 34 compares the RF-AGC voltages 17a to 17n supplied from the front-end circuits 11a to 11n, respectively. The control section 34 controls the switch 12 in accordance with the result of the comparison so that an IF signal 22, supplied from an IF-AGC 23 which is connected, via the level detection section 32, to a front-end circuit having the smallest gain, is supplied to the digital demodulation section 13.

As discussed in the second embodiment, when all the broadcast signals received via the antennas 10 have signal levels of not higher than the predetermined level, all the front-end circuits 11a to 11n are a maximum gain, i.e., have the same gain.

The control section 34 receives (a) the RF-AGC voltages 17a to 17n from the front-end circuits 11a to 11n, respectively and (b) the signal level information signals 31a to 31n, which indicate signal levels of the IF signals 16a to 16n, from the level detection sections 32a to 32n, respectively.

The control section 34 controls the switch 12 in accordance with the RF-AGC voltages 17a through 17n and the signal level information 31a to 31n. Specifically, the control section 24 first compares the RF-AGC voltages 17a to 17n If the comparison result reveals that the RF-AGC voltages 17a to 17n have the same gain, then the control section 34 compares the signal level information 31a to 31n so as to identify an IF signal 16 having the highest signal. Further, the control section 34 outputs a control signal to the switch 12 so that the switch 12 outputs to the digital demodulation section 13 the IF signal 23 obtained by the amplification of the IF signal 16 having the highest signal level.

As explained in the second embodiment, the IF signal 16 having the highest signal level is an IF signal 16 into which a broadcast signal, received via the antenna which is in the best reception condition, has been converted by the front-end section 11.

As discussed above, the diversity device 3 of the third embodiment is capable of selecting a broadcast signal which is in the best reception condition, even in a case where all the broadcast signals received via the antennas 10 have signal levels of not higher than a certain level and therefore all the front-end circuits 11a to 11n have the same.

The arrangement and the operation of the control section 34 arc the same as those of the control section 24, except that the control section 34 receives the signal level information signals 31a to 31n from the level detection sections 32, whereas the control section 24 of the second embodiment receives the IF-AGC signals 21a to 21n. Further explanation regarding the arrangement and the operation of the control section 34 is omitted.

The diversity device 3 of the third embodiment includes the IF-AGCs 23a to 23n that amplify the IF signals 16a to 16n supplied from the level diction section 32a to 32n, respectively. However, the present invention is not limited to this. Alternatively, the diversity device 3 may be arranged such that, after the switch 12 selects an IF signal 16 generated from a broadcast signal which is in the best reception condition, the IF signal 16 thus selected is amplified by an IF-AGC so as to have a predetermined target level, and is then supplied to the digital demodulation section 13. This reduces the number of the IF-AGCs 23 in the diversity device 3, thereby further downsizing the diversity device 3.

### Fourth Embodiment

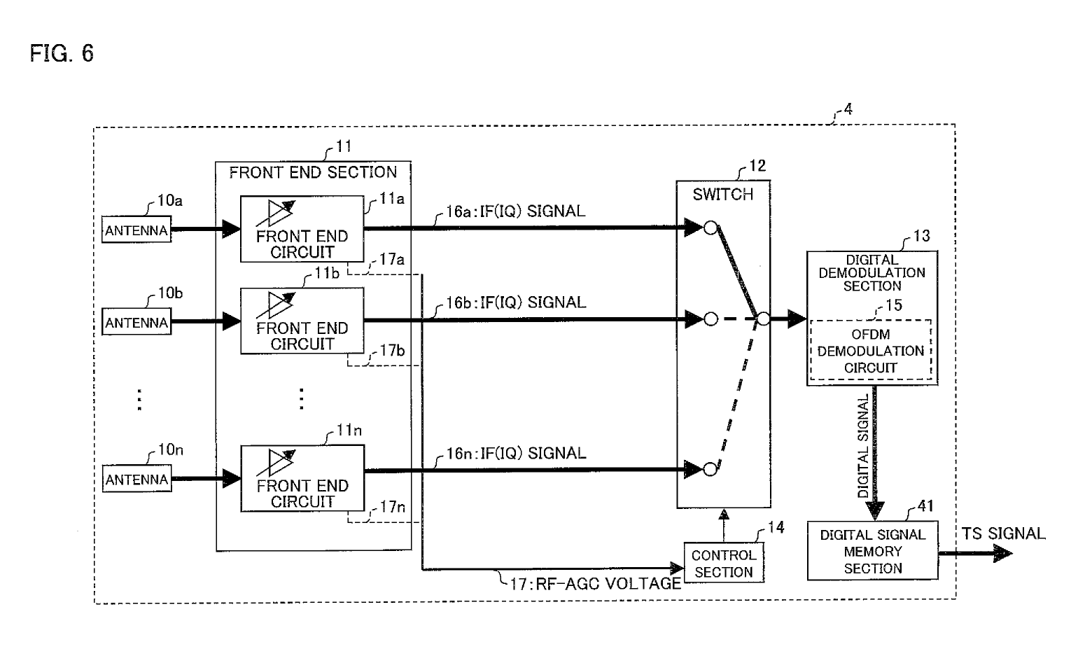

The following explains a diversity device 4 of the fourth embodiment of the present invention with reference to FIG. 6. FIG. 6 is a block diagram illustrating an arrangement of the diversity device 4 of the fourth embodiment.

The diversity device 4 of the fourth embodiment, further to the diversity device 1 of the first embodiment, includes a digital signal memory section 41 in which digital signals demodulated by the digital demodulation section 13 are stored. It should be noted that the fourth embodiment explains constituent members different from those of the first embodiment, and that same members in the fourth embodiment as those in the first embodiment are assigned the same reference numerals and the description of the members is omitted.

(Arrangement of Diversity Device 4)

As illustrated in FIG. 6, the diversity device 4, further to the diversity device 1 of the first embodiment, includes the digital signal memory section 41 in which digital signals demodulated by the digital demodulation section 13 are stored.

(Operation of Diversity Device 4)

The following explains how the diversity device 4 operates. First, a switch 12 selects an IF signal 16 generated from a broadcast signal which is in the best reception condition. The IF signal 16 thus selected is demodulated into a digital signal by a digital demodulation section 13, and is then supplied to the digital signal memory section 41.

In the digital signal memory section 41, the digital signals supplied from the digital demodulation section 13 are stored for a certain period of time, and a digital signal stored in the digital signal memory section 41 is sent out as a TS signal.

In a case where one broadcast signal, received via one of the antennas 10 that is in the best reception condition, is switched into another broadcast signal received via another one of the antennas 10, in other words, in a case where the control section 14 causes the switch 12 to switch between one broadcast signal and another broadcast signal, a digital signal outputted from the digital demodulation section 13 is interrupted. According to the present embodiment, the diversity device 4 includes the digital signal memory section 41 in which the digital signals supplied from the digital demodulation section 13 are stored for a period of time. As such, even in a case where a digital signal from the digital demodulation section 13 is interrupted due to a switching operation of the switch 12, the digital signal stored in the digital signal memory section 41 covers such an interrupted digital signal. This allows the diversity device 4 to supply a TS signal without being interrupted, even in a case where a broadcast signal received via one of the antennas 10 that is in the best reception condition is switched to another broadcast signal received via another one of the antennas 10.

The diversity device 4 of the fourth embodiment deals with the case where the digital signal memory section 41 is provided in addition to the arrangement of the diversity device 1 of the first embodiment. However, the present invention is not limited to this. A digital signal memory section 41 may be provided in the diversity device 2 of the second embodiment and in the diversity device 3 of the third embodiment.

### Fifth Embodiment

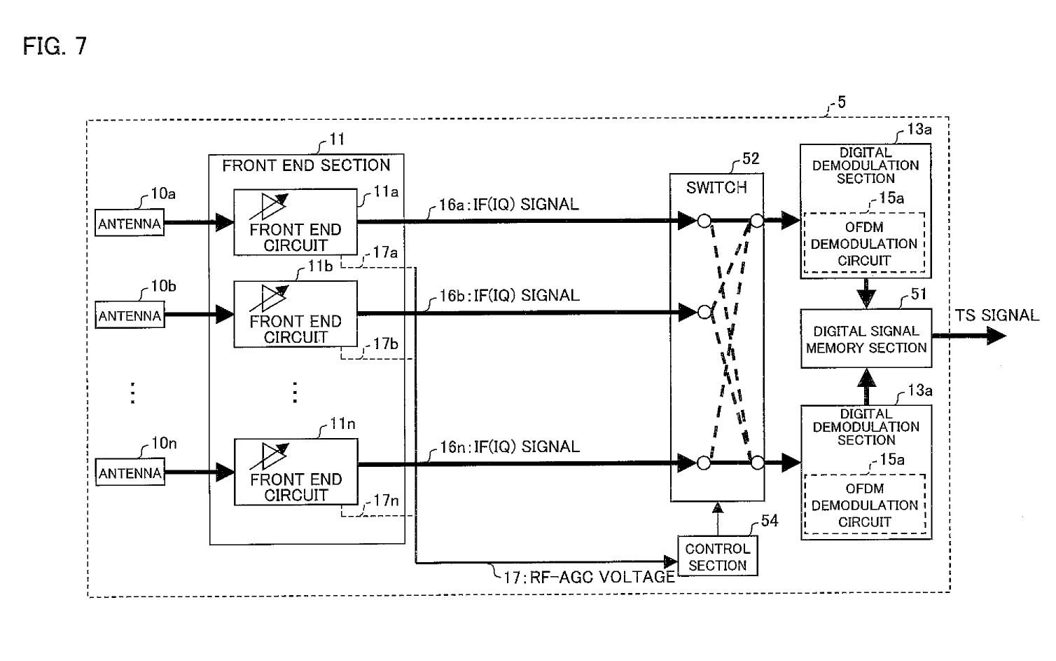

The following explains a diversity device 5 of the fifth embodiment of the present invention with reference to FIG. 7. FIG. 7 is a block diagram illustrating an arrangement of the diversity device 5 of the fifth embodiment. It should be noted that the fifth embodiment explains constituent members different from those of the first embodiment, and that same members in the fifth embodiment as those in the first embodiment are assigned the same reference numerals and the description of the members is omitted.

(Arrangement of Diversity Device 5)

As illustrated in FIG. 7, the diversity device 5 includes (i) a plurality of antennas 10a to 10n, (ii) a front-end section 11 that includes a plurality of front-end circuits 11a to 11n, (iii) a switch 52 (selecting means) that selects two of the IF signals 16 supplied from the front-end section 11, (iv) a control section 54 that controls the switch 52, (v) a digital demodulation section 13a that demodulates into a digital signal one of the IF signals 16 selected by the switch 52, (vi) a digital demodulation section 13b that demodulates into a digital signal the other of the IF signals 16 selected by the switch 52, and (vii) a digital signal memory section 51 in which the two digital signals demodulated by the digital demodulation sections 13a and 13b are stored.

(Operation of the Diversity Device 5)

The following explains how the diversity device 5 operates. First, the front-end circuits 11a to 11n cause broadcast signals received via the antennas 10 to be subjected to frequency conversions and amplification, and supply to the switch 52 the IF signals 16a to 16n that correspond to the broadcast signals, respectively. Then, the switch 52, in accordance with a control signal supplied from the control section 54, selects two of the IF signals 16 thus received. Subsequently, the switch 52 outputs one of the two IF signals 16 thus selected to the digital demodulation section 13a, and the other of the two IF signals 16 to the digital demodulation section 13b.

The control section 54 receives RF-AGC voltages 17a to 17n from the front-end circuits 11a to 11n, and compares the RF-AGC voltages. Then, the control section 54, based on the comparison of the RF-AGC voltages 17a to 17n, identifies: a front-end circuit that has the smallest gain; and a front-end circuit that has the second smallest gain. Subsequently, the control section 54 supplies a control signal to the switch 52 so that the switch 52 selects the two IF signals 16 supplied from the two front-end circuits identified as above.

The digital demodulation section 13a demodulates into a digital signal the IF signal 16 supplied from the switch 52, with use of an OFDM demodulation circuit 15a (first demodulator means) in the digital demodulation section 13a, and supplies the digital signal thus demodulated to the digital signal memory section 51. Similarly, the digital demodulation section 13b demodulates into a digital signal the IF signal 16 supplied from the switch 52 with use of an OFDM demodulation circuit 15b (second demodulator means) in the digital demodulation section 13b, and supplies the digital signal thus demodulated to the digital signal memory section 51.

The digital signals supplied from the digital demodulation sections 13a and 13b are stored in a memory in the digital signal memory section 51. The digital signal memory section 51 sends out as a TS signal the digital signal corresponding to the IF signal 16 supplied from the front-end circuit having the smallest gain. Note that the digital signal memory section 51 receives from the control section 54 information on which of the digital demodulation sections 13a and 13b has received from the switch 52 the IF signal 16 supplied from the front-end circuit having the smallest gain. This allows the digital signal memory section 51 to determine which of the digital demodulation sections 13a and 13b outputs the digital signal that corresponds to the IF signal 16 supplied from the front-end circuit having the smallest gain.

As discussed above, in the diversity device 5, (i) the IF signal 16 received via the antenna 10 that is in the second best reception condition and (ii) the IF signal 16 received via the antenna 10 that is in the best reception condition are subjected to digital demodulation. As such, in a case where the best reception condition of the antenna 10 becomes worse than the second best reception condition of the antenna 10, it is possible to output a TS signal by carrying out an immediate switching to the digital signal that corresponds to the broadcast signal received via the antenna 10 which is in the second best reception condition. This prevents a data interruption of the TS signal to be outputted, even in a case where a switching is carried out from one of the antennas 10 that is in the best reception condition to another one of the antennas 10. Further, since the two digital signals are stored in the digital signal memory section 51, it is possible to shorten the time lag between the reception of a broadcast signal received via the antenna 10 and a TS signal to be outputted.

The fifth embodiment deals with a case where the control section 54 compares the RF-AGC voltages 17 supplied from the front-end circuits 11a to 11n, and the switch 52 selects two of the IF signals 16 in accordance with the comparison result. However, the present invention is not limited to this. Alternatively, the diversity device 5 may be so arranged as to (a) include the IF-AGCs 23a through 23n as in the second embodiment, (b) cause the control section 54 to compare the IF-AGC voltages 21, and, in a case where the REF-AGC voltages 17 have the same gain, i.e. the front-end circuits 11a to 11n have a single gain, (c) control the switch 52 in accordance with the result of the comparison of the IF-AGC voltages 21. Further alternatively, the diversity device 5 may be so arranged as to (a) include the IF-AGCs 23a to 23n and the level detection sections 32a to 32n as in the third embodiment, (b) cause the control section 54 to compare the signal level information 31, and, in a case where the RF-AGC voltages 17 have the same gain, i.e. the front-end circuits 11a to 11n have a single gain, (c) control the switch 52 in accordance with the result of the comparison of the signal level information 31.

According to the first to fifth embodiments, the front-end circuits 11a to 11n cause broadcast signals to be subjected to frequency conversions so that the IF signals 16 are generated. However, the present invention is not limited to this. Each of the front-end circuits 11a to 11n may include an I/Q quadrature detector for converting a broadcast signal directly into a baseband signal including an I signal and a Q signal whose phase difference is 90 degrees so that a broadcast signal is directly converted into a baseband signal.

Further, according to the above embodiments, broadcast signals based on broadcast waves are received via the antennas 10. However, the present invention is not limited to this. The present invention covers an arrangement in which electric wave signals, for use in devices such as portable phones, other than broadcast waves are received via antennas 10.

The present invention is not limited to the description of the embodiments above, but may be altered by a skilled person within the scope of the claims. An embodiment based on a proper combination of technical means disclosed in different embodiments is encompassed in the technical scope of the present invention.

A diversity device of the present invention may be arranged as below.

(First Arrangement)

A diversity reception device, including: a plurality of input terminals via which plural broadcast wave are received; a plurality of front-end sections, each including a first variable-gain amplifier, in which the plural broadcast wave are amplified, are subjected to frequency conversions, and are outputted as stable intermediate frequency signals; and a control section for (a) comparing gains of the first variable-gain amplifiers in the front-end sections and (b) selecting and outputting an intermediate frequency signal that is supplied from a front-end section which is in the best reception condition.

(Second Arrangement)

A diversity reception device, including: a plurality of input terminals via which plural broadcast wave are received; a plurality of front-end sections, each including a first variable-gain amplifier, in which the plural broadcast waves are converted into two baseband signals of an I signal and a Q signal whose that phase difference is 90 degrees; and a control section for (a) comparing gains of the first variable-gain amplifiers in the front-end sections, and (b) selecting and outputting an baseband signal that is supplied from the front-end section which is in the best reception condition.

(Third Arrangement)

A diversity reception device according to the first or second arrangement, further including a wave detection circuit for detecting the intermediate frequency signals or the baseband signals outputted from the front-end sections, wherein (a) signal levels of the output signals are compared, (b) only an intermediate frequency signal or of a baseband signal that has the greatest signal level are selected, and (c) digital demodulation is carried out with respect to the signal thus selected.

(Fourth Arrangement)

A diversity reception device according to any one of the first through third arrangements, further including second variable-gain amplifiers for amplifying the intermediate frequency signals or the baseband signals outputted from the front-end sections, respectively, wherein (a) gains of the second amplifiers are compared, (b) only an intermediate frequency signals or only a baseband signal that is in the best reception condition, and (c) the signal thus selected is subjected to digital demodulation.

(Fifth Arrangement)

A diversity reception device according to any one of the first to fourth arrangements, further including a storage device in which, for a certain period of time, the digital signal obtained by demodulation to which the intermediate frequency signal or the baseband signal, outputted from the front-end section that is in the best reception condition, has been subjected.

(Sixth Arrangement)

A diversity reception device according to any one of the first to fifth arrangements, further including first and second digital demodulation circuits for two receiving system, the first digital demodulation circuit demodulating the intermediate frequency signal or the baseband signal that is supplied from the front-end section that is in the best reception condition, the second digital demodulation circuit demodulating an intermediate frequency signal or a baseband signal that is supplied from a front-end section that is in the second best reception condition, wherein, in a case where a reception condition of the first receiving system becomes worse than the second receiving system, the first receiving system is switched into the second receiving system.

As discussed above, the diversity device of the present invention includes: a plurality of input terminals via which electric wave signals are respectively received; and a plurality of signal converter means for amplifying signal levels of the electric wave signals received via the plurality of input terminals, respectively, target signal levels of output signals supplied from the plurality of signal converter means being set in advance, the diversity device further including: comparing means for comparing first gains of the plurality of signal converter means; and selecting means for selecting, in accordance with a comparison result obtained by the comparing means, a first output signal supplied from a signal converter means, among the plurality of signal converter means, having a smallest first gain.

The above arrangement enables provision of a diversity device that is capable of (i) selecting, from among a plurality of electric wave signals, an electric wave signal which is in the best reception condition; and (ii) being downsized.

The present invention allows a selection of an electric wave signal which is in the best reception condition, from among the electric wave signals received via a plurality of input terminals. Thus, the present invention is particularly applicable to an apparatus such as an in-vehicle broadcast receiving apparatus having a plurality of antennas.

The diversity device of the present invention may preferably further include: level detection means for detecting signal levels of output signals that are outputted from the plurality of signal converter means; and level comparing means for comparing the signal levels of the output signals, wherein, in a case where the plurality of signal converter means have a single first gain, the selecting means selects, from among the output signals supplied from the plurality of signal converter means, an output signal that has a greatest signal level, in accordance with a comparison result obtained by the level comparing means.

When the signal levels of all the electric wave signals received via the input terminals are lower than a certain level, i.e. the signal levels are so low that the signal converter means are incapable of amplifying such signal levels to the desired level, first gains of the signal converter means are the maximum, i.e., such first gains are the same as described above. In this case, the signal levels of output signals that are outputted from the signal converter means are lower than the predetermined target level. In addition, such signal levels are different from one another, proportionately to the signal levels of the electric wave signals before the amplification.

According to the above arrangement, the diversity device of the present invention, in a case where first gains of the signal converter means are the same, detects and compares the signal levels of output signals that are outputted from the signal converter means, and then selects the output signal having the highest signal level. Since all of such first gains of the signal converter means are the maximum, the output signal having the highest signal level refers to an output signal obtained by amplification of an electric wave signal that has the highest signal level.

As discussed above, an electric wave signal that has the highest signal level refers to the electric wave signal received via the input terminal which is in the best reception condition. Consequently, the diversity device of the present invention having the above arrangement is capable of selecting the electric wave signal received via the input terminal which is in the best reception condition, even in a case where the signal levels of all the electric wave signals received are lower than the minimum level, and the signal converter means are therefore incapable of amplifying such signal levels to the desired level.

The diversity device of the present invention may preferably further include: a plurality of amplifiers for amplifying the output signals, outputted from the plurality of signal converter means, so that the output signals have the target signal levels, respectively; and gain comparing means for comparing second gains of the plurality of amplifiers, wherein, in a case where the plurality of signal converter means have a single first gain, the selecting means selects an output signal amplified by an amplifier, among the plurality of amplifiers, that has a smallest second gain, in accordance with a comparison result obtained by the gain comparing means.

As described above, when the signal levels of all the electric wave signals received via the input terminals are so low that the signal converter means are incapable of amplifying such signal levels to the desired level, gains of the signal converter means are the same.

According to the above arrangement, the diversity device of the present invention includes the plurality of amplifiers for amplifying to the desired level output signals that are outputted from the signal converter means, respectively. Further, the diversity device, in a case where first gains of the signal converter means are the same, compares second gains of the plurality of amplifiers and then selects the output signal amplified by the amplifier that has the smallest second gain.

Since the amplifiers amplify to the desired signal level output signals supplied from the signal converter means, the output signal amplified by the amplifier that has the smallest second gain refers to the output signal obtained by the amplification of the output signal that has the highest signal level among the plurality of output signals that are outputted from the signal converter means. Further, since all of the first gains of the signal converter means are the maximum, the output signal having the highest signal level refers to an output signal obtained by amplification of an electric wave signal that has the highest signal level. In addition, the electric wave signal that has the highest signal level, as described above, refers to the electric wave signal received via the input terminal which is in the best reception condition.

As discussed above, the diversity device of the present invention having the above arrangement is capable of selecting the electric wave signal received via the input terminal which is in the best reception condition, even in a case where the signal levels of all the electric wave signals received are lower than the minimum level and the signal converter means are therefore incapable of amplifying such signal levels to the desired level.

The diversity device of the present invention may preferably further include first demodulator means for demodulating the first output signal selected by the selecting means to a first digital signal.

According to the above arrangement, the first demodulator means demodulates the output signal selected by the selecting means. Therefore, the diversity device only requires one first demodulator means for demodulating one output signal selected. In other words, the above arrangement eliminates the need to include demodulator means that would otherwise be required in order to demodulate other output signals, which are not selected by the selecting means, i.e. the need to include demodulator means as many as the input terminals, which enables further downsizing of the diversity device.

The diversity device of the present invention may preferably further include memory means for storing the first digital signal.

In a case where the selecting means selectively switches to another output signal due to variation in the reception condition of the input terminals, the data of the digital signal generated by demodulation of the previous output signal is incomplete.

The above arrangement allows allotment of the digital signal stored by the memory means in compensation for the incomplete data. This enables the digital signal supplied from the memory means to be stable and have complete data, even if the data of the digital signal obtained by demodulation performed by the first demodulator means is incomplete.

The diversity device of the present invention may preferably be arranged such that the selecting means further selects a second output signal different from the first output signal, the diversity device further including second demodulator means for modulating the second output signal selected by the selecting means to a second digital signal, the selecting means selecting, as the second output signal, an output signal supplied from a signal converter means, among the plurality of signal converter means, that has a second smallest first gain, in accordance with a comparison result obtained by the comparing means.

As described above, the smaller first gain the signal converter means has, the better reception condition the electric wave signal, which is received by the signal converter means, has. Therefore, the electric wave signal received by the signal converter means having the second smallest first gain is an electric wave signal which is in the second best reception condition.

The above arrangement enables (i) the selecting means to select the electric wave signal which is in the second best reception condition in addition to the electric wave signal which is in the best reception condition, and (ii) the second demodulator means to demodulate the electric wave signal which is in the second best reception condition into a digital signal.

The above arrangement advantageously enables the generation of two digital signals, one of which corresponds to the electric wave signal received via the input terminal which is in the best reception condition and the other of which corresponds to the electric wave signal received via the input terminal which is in the second best reception condition. Even in a case where the data of the digital signal obtained by the demodulation performed by the first demodulator means is incomplete, as the selecting means switches to another output signal due to decrease in the reception of the input terminal which is in the best reception condition, the digital signal obtained by the demodulation performed by the second demodulator means is allotted in compensation for the incomplete data. The diversity device is thereby capable of outputting stable digital signals having complete data.

The diversity device of the present invention may preferably be arranged such that the plurality of signal converter means cause the electric wave signals to be subjected to frequency conversions and amplification so as to output intermediate frequency signals as the output signals, respectively.

The above arrangement allows the signal converter means to generate the intermediate frequency signals by frequency conversions and amplification of the electric wave signals. This facilitates circuit construction of the signal converter means, as compared to the case in which the electric wave signal is converted into another signal and amplified.

The diversity device may preferably be arranged such that the plurality of signal converter means (i) convert the electric wave signals into baseband signals including an I signal and a Q signal whose phase difference is 90 degrees and (ii) amplify and output the I signal and the Q signal as the output signals, respectively.

The above arrangement allows the signal converter means to convert the electric wave signals directly into the I signal and the Q signal without conversion to an intermediate signal. This advantageously reduces influence of electric waves present on adjacent channels and interference waves, upon the baseband signal outputted from the signal converter means, as compared to the case in which the electric wave signal is intermediately converted into a different signal.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A diversity device, comprising:
a plurality of input terminals via which electric wave signals are respectively received; and
a plurality of signal converter means for amplifying signal levels of the electric wave signals received via the plurality of input terminals, respectively,
target signal levels of output signals supplied from the plurality of signal converter means being set in advance,
said diversity device further comprising:
comparing means for comparing first gains of the plurality of signal converter means; and
selecting means for selecting, in accordance with a comparison result obtained by the comparing means, a first output signal supplied from a signal converter means, among the plurality of signal converter means, having a smallest first gain.

2. A diversity device according to claim 1, further comprising:
level detection means for detecting signal levels of output signals that are outputted from the plurality of signal converter means; and
level comparing means for comparing the signal levels of the output signals,
wherein, in a case where the plurality of signal converter means have a single first gain, the selecting means selects, from among the output signals supplied from the plurality of signal converter means, an output signal that has a greatest signal level, in accordance with a comparison result obtained by the level comparing means.

3. A diversity device according to claim 1, further comprising:
a plurality of amplifiers for amplifying the output signals, outputted from the plurality of signal converter means, so that the output signals have the target signal levels, respectively; and
gain comparing means for comparing second gains of the plurality of amplifiers,
wherein, in a case where the plurality of signal converter means have a single first gain, the selecting means selects an output signal amplified by an amplifier, among the plurality of amplifiers, that has a smallest second gain, in accordance with a comparison result obtained by the gain comparing means.

4. A diversity device according to claim 1, further comprising,
first demodulator means for demodulating the first output signal selected by the selecting means to a first digital signal.

5. A diversity device according to claim 4, further comprising,
memory means for storing the first digital signal.

6. A diversity device according to claim 5, wherein the selecting means further selects a second output signal different from the first output signal,
said diversity device further comprising,
second demodulator means for modulating the second output signal selected by the selecting means to a second digital signal,
said selecting means selecting, as the second output signal, an output signal supplied from a signal converter means, among the plurality of signal converter means, that has a second smallest first gain, in accordance with a comparison result obtained by the comparing means.

7. A diversity device according to claim 1,
wherein the plurality of signal converter means cause the electric wave signals to be subjected to frequency conversions and amplification so as to output intermediate frequency signals as the output signals, respectively.

8. The diversity device according to claim 1,
wherein the plurality of signal converter means (i) convert the electric wave signals into baseband signals including an I signal and a Q signal whose phase difference is 90 degrees and (ii) amplify and output the I signal and the Q signal as the output signals, respectively.
